(19) United States
(12) Patent Application Publication
(10) Pub. No.: US 2023/0413242 A1
(43) Pub. Date: Dec. 21, 2023

(54) COMMUNICATION METHOD, ELECTRONIC DEVICE AND STORAGE MEDIUM

(71) Applicant: BEIJING XIAOMI MOBILE SOFTWARE CO., LTD., Beijing (CN)

(72) Inventor: Yang LIU, Beijing (CN)

(21) Appl. No.: 18/034,843

(22) PCT Filed: Nov. 2, 2020
(86) PCT No.: PCT/CN2020/125963

§ 371 Date: May 1, 2023

(51) Int. Cl. H04W 72/04

(52) U.S. Cl. CPC H04W 72/04

(57) ABSTRACT

A communication method, an electronic device and a storage medium. The method, performed by a sending device, includes receiving first information configured to indicate idle channels, and sending information based on the idle channels indicated by the first information. Receiving the first information may include receiving the first information sent by a first device, wherein the idle channels indicated by the first information are determined by the first device by receiving signal information sent by each of second devices and determining the idle channels based on the signal information receive. Sending information may include selecting one channel from the idle channels indicated by the first information and sending the information based on the channel selected..

### CROSS REFERENCE TO RELATED APPLICATIONS

This application is a national phase application based on International Application No. PCT/CN2020/125963, filed Nov. 2, 2020, the entire content of which is incorporated by reference.

### TECHNICAL FIELD

The present disclosure relates to the field of wireless communication technologies, in particular to, a communication method, an electronic device and a storage medium.

### BACKGROUND

Radio spectrum resources are becoming increasingly scarce as use of wireless electronic devices expands to an increasing number of applications. Using spectrum resources more reasonably and efficiently is an important and fundamental issue to be considered in wireless communication design.

Listen Before Talk (LBT), sometimes referred to as Listen Before Transmit (LBT), is a technique used in the wireless communication. A radio transmitter first senses its radio environment before starting transmission. A radio device may search for a spectrum resource unoccupied by other devices by means of LBT. That is, the device first listens for a signal of a desired frequency/channel to check whether the frequency/channel is occupied by other devices. The frequency/channel will be used in response to the frequency/channel being unoccupied by other devices.

### SUMMARY

Embodiments of the present disclosure provide a communication method, an electronic device and a storage medium.

According to a first aspect, an embodiment of the present disclosure provides a communication method, performed by a sending device. The method includes:
receiving first information, in which the first information is configured to indicate idle channels;
sending information based on the idle channels indicated by the first information.

According to a second aspect, an embodiment of the present disclosure provides a communication method, performed by a first device. The method includes:
obtaining signal information sent by each of second devices;
determining idle channels based on the signal information received;
sending first information based on the idle channels determined, in which the first information is configured to indicate the idle channels.

According to a third aspect, an embodiment of the present disclosure provides a communication method, performed by a second device. The method includes
acquiring signal information; and
sending the signal information to a first device, in which the signal information is configured for the first device to determine an idle channel.

According to a fourth aspect, an embodiment of the present disclosure provides an electronic device. The electronic device includes a processor and a memory, coupled with each other.

The memory is configured to store a computer program; and

The processor is configured to implement the method provided by any one of possible implementations as described in at least one of a first aspect, a second aspect, and a third aspect when calling the computer program.

According to a fifth aspect, an embodiment of the present disclosure provides a computer readable storage medium having a computer program stored thereon. The computer program is caused to implement the method provided by any one of possible implementations as described in at least one of a first aspect, a second aspect, and a third aspect when executed by a processor.

### BRIEF DESCRIPTION OF THE DRAWINGS

In order to more clearly describe the technical solutions in embodiments of the present disclosure, the following briefly introduces the accompanying drawings required for describing the embodiments. Obviously, the accompanying drawings in the following description are only embodiments of the present disclosure. Other drawings can be obtained based on these drawings, for those skilled in the art, without inventive labor.

FIG. 1 is a flowchart illustrating a communication method according to an embodiment of the present disclosure.

FIG. 2 is a flowchart illustrating another communication method according to an embodiment of the present disclosure.

FIG. 3 is a flowchart illustrating yet another communication method according to an embodiment of the present disclosure.

FIG. 4 is a schematic diagram illustrating a structure of a communication network according to an embodiment of the present disclosure.

FIG. 5 is a schematic diagram illustrating a structure of a communication apparatus according to an embodiment of the present disclosure.

FIG. 6 is a schematic diagram illustrating a structure of another communication apparatus according to an embodiment of the present disclosure.

FIG. 7 is a schematic diagram illustrating a structure of yet another communication apparatus according to an embodiment of the present disclosure.

FIG. 8 is a schematic diagram illustrating a structure of an electronic device according to an embodiment of the present disclosure.

### DETAILED DESCRIPTION

Reference will be made clearly and completely in the technical solution of the embodiments of the disclosure with the accompanying drawings. Obviously, the embodiments described here are only part of the embodiments of the disclosure and are not all embodiments of the disclosure. Based on the embodiments of the disclosure, other embodiments obtained by those skilled in the art without inventive works are within the scope of the disclosure.

It should be noted that terms “first”, “second”, etc. in specification and claims of the present disclosure, as well as the accompanying drawings, are used to distinguish similar objects, without necessarily describing a specific order or sequence. It should be understood that data used in this way can be interchanged in an appropriate case, so that embodiments described herein can be implemented in orders other than those illustrated or described herein. In addition, terms “including” and “having”, as well as any variations thereof, are intended to cover non-exclusive inclusion. For example, a process, a method, a product, or a device that includes a series of steps or units, need not be limited to those clearly listed steps or units, but may include other steps or units that are not clearly listed or inherent to the process, the method, the product, or the device.

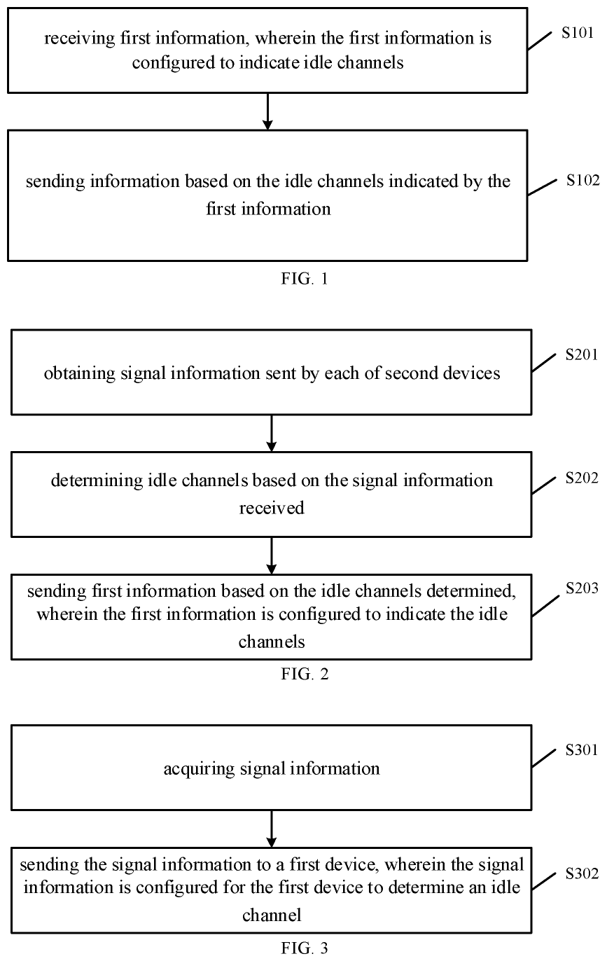

FIG. 1 is a flowchart illustrating a communication method according to an embodiment of the present disclosure. The method may be performed by any electronic device, especially any device to be sent information (referred to as a sending device). The information sent may be data, or may be control information, signaling, etc. A specific type of the information sent is not limited in embodiments of the present disclosure. The sending device may be a base station or a user equipment, or a radio device, or a wireless transmitting device, or other devices that require to send data. A data sending device may receive first information. The first information is configured to indicate idle channels, and send information based on the idle channels indicated by the first information.

As illustrated in FIG. 1, the communication method provided in an embodiment of the present disclosure may include the following steps.

At step S101, first information is received. The first information is configured to indicate idle channels.

At step S102, information is sent based on the idle channels indicated by the first information.

In an embodiment, an idle channel may also be referred to as an idle channel resource, a channel not occupied, a channel resource not occupied, an unoccupied channel, an unoccupied channel resource, a channel in an idle state, a channel resource in an idle state, etc. The channel resource may specifically be a time domain resource and/or a frequency domain resource, such as a spectrum resource occupied by a channel.

The first information is essentially an indication information, which may be used to indicate the idle channels or described as indicating an idle channel set. The channel set may correspond to at least one channel. The first information may also be referred to as first indication information, etc. A specific manner for realizing indication of the idle channels by means of the first information is not limited in an embodiment of the present disclosure. For example, the first information may be explicit indication information, and the idle channels may be known by parsing the first information. The first information may also be implicit indication information, and the sending device may determine the idle channels based on the first information in a predetermined manner after receiving the first information.

For those skilled in the art, it is clear that in a practical application, sending of information is generally done after encoding the information. Correspondingly, after receiving the first information, the sending device may decode the first information by a corresponding decoding manner to obtain a content included in the first information.

It should be noted that names of various related information in an embodiment of the present disclosure are only illustrative and not unique, and may also use other names. Similarly, the expression of the idle channel is not limited in an embodiment of the present disclosure.

In an embodiment, the base station is required to send the information based on the idle channels in response to the data sending device is the base station. The user equipment is required to send the information based on the idle channels in response to the data sending device is the user equipment. A radio device is required to send the information based on the idle channels in response to the data sending device is another radio device.

The information may be understood as information to be sent by the data sending device. The information may be scheduling/control information, or may be data, which will not be limited herein.

In an optional embodiment, the step S102, namely sending the information based on the idle channels indicated by the first information, may be implemented according to the following steps.

At step S1021, one channel is selected from the idle channels indicated by the first information.

At step S1022, the information is sent based on the channel selected.

A specific implementation of selecting one channel from the idle channels will not be limited in an embodiment of the present disclosure. In an embodiment, any one channel may be selected from the idle channels indicated by the first information.

For example, in an optional embodiment, selecting one channel from the idle channels indicated by the first information includes randomly selecting one channel from the idle channels indicated by the first information.

The specific implementation of selecting one channel from the idle channels may be randomly selecting one channel from the idle channels indicated by the first information.

In an optional embodiment, sending the information based on the channel selected includes sending the information based on the channel selected in response to the channel selected being unoccupied.

In a practical application, in order to avoid a resource conflict between different sending devices, one sending device is required to determine whether the channel selected is idle or not occupied by other devices before sending the information. Therefore, before sending the information through the channel selected, the sending device may first determine whether the channel selected is occupied, and may send the information through the channel in response to the channel being unoccupied, which may avoid failure of information sending due to the resource conflict.

A specific implementation for determining whether the channel is occupied, which will not be limited in an embodiment of the present disclosure, may employ any existing method for determining whether the channel is occupied. For example, any electronic device may send information through broadcasting to inform other devices that the electronic device has already occupied a certain channel or channel resource when the electronic device is required to send information by using the channel or channel resource. As such, other devices may know which channel or channel resource is occupied by the electronic device by means of the information.

According to the solution provided an embodiment of the present disclosure, the information is sent based on the idle channels indicated by the first information received, thus avoiding the existing method of searching a plurality of channels or even all channels within a specific spectrum to determine the idle channels, and directly determining the idle channels based on indication of the first information. Therefore, efficiency of determining the idle channels may be improved and the utilization rate of the channel resource may further be improved.

In a case where the channel selected is occupied, there are two alternative methods to solve it.

Method A1: the communication method may further include:
receiving second information in response to the channel selected being occupied, in which the second information is configured to indicate an idle channel; and
sending the information based on the idle channel indicated by the second information.

In other words, when the channel selected is occupied by another device, the second information may be received, and the idle channel may be re-determined based on the second information. It can be understood that essence of the second information and the first information is the same, both of which are information configured to indicate the idle channel, but differ in their reception occasions. In an embodiment, the second information may also be referred to as second indication information or the like.

The idle channels indicated by the first and second information may be the same or different.

In a practical application, occupancy of a channel may change at any time. When the channel selected is occupied, in order to ensure real-time of information obtained, the sending device may receive the second information again and send the information based on the idle channel indicated by the second information received again. The manner of sending the information based on the idle channel indicated by the second information is the same as the manner of sending the information based on the idle channels indicated by the first information, which will not be repeated herein.

An implementation of selecting the channel to be sent the information from the idle channel indicated by the second information may refer to the specific implementation of the step S1021, such as selecting one channel in a random selection manner to send information to be sent.

It should be noted that when an occupied situation is still occurred under sending the information based on the idle channel indicated by the second information, the steps 203 to 204 may be re-executed, that is, when the channel selected is occupied, information configured to indicate an idle channel may be received again, and the information may be send based on the idle channel indicated by the information received again.

According to this embodiment, when the channel selected is occupied, the new second information may be received again, and then the information may be sent based on the idle channel indicated by the second information. Therefore, a situation where the information cannot be sent or fails to be sent due to the channel selected being occupied may be avoided. Moreover, since the idle channel indicated by the second information is a new idle channel, selecting a channel from the new idle channel to send the information may improve a success rate of sending information.

Method A2: sending the information based on the channel selected may include:
in response to the channel selected being occupied, re-selecting one channel from the idle channels indicated by the first information other than the channel selected; and
sending the information based on the channel re-selected.

As an alternative, when the channel selected is occupied by another device to be sent information, one channel which is not the channel having already selected may be selected from the idle channels indicated by the first information. An implementation of selecting one channel from the idle channels indicated by the first information other than the channel selected may refer to the specific implementation method of the step S1021, such as selecting one channel in a random selection manner to send information to be sent.

As an example, assumed that there are 10 idle channels indicated by the first information, namely channel 1, channel 2, channel 3 . . . channel 10. A channel selected for the first time is channel 3. When sending the information based on channel 3, and channel 3 is found to be occupied, another channel may be selected from the remaining 9 channels except for channel 3, for example, channel 6 is selected, the information may be sent based on channel 6.

It is understandable that the above example is only illustrative, which will not be limited in this embodiment.

The information is sent based on the channel re-selected from the idle channels indicated by the first information other than the occupied channel. For example, the information may be sent through channel 6. Of course, in response to the channel re-selected is also occupied, another idle channel may be re-selected, or information indicating the idle channel may be received again and the information may be sent based on the idle channel indicated by the information received again.

According to this embodiment, when a situation where the channel selected is occupied occurs, one channel may be selected from the remaining channels of the idle channels indicated by the first information to send the information. Therefore, failure to send the information due to the channel selected being occupied may be avoided, and a success rate of sending the information may be improved.

It should be noted that the two alternative embodiments when the channel selected is occupied provided in the present disclosure may be implemented separately or in combination. For example, a threshold for the number of repeated selections may be set. In response to the number for consecutive repeated selections of the idle channels being greater than or equal to the threshold, receiving the information configured to indicate the idle channels again may be performed, and the information is sent based on the idle channels indicated by the information received again. In response to the number for consecutive repeated selections of the idle channels being less than or equal to the threshold, the step of re-selecting the idle channel may be performed, and the information is sent based on the idle channel re-selected. For example, a time threshold may be set. In response to a time difference between a current time point and a time point when the first information is received being greater than or equal to the time threshold, it is required to receive the information configured to indicate the idle channel again, and send the information cased on the idle channel indicated by the information received again. In response to the time difference between the current time point and the time point when the first information is received being less than or equal to the time threshold, one channel may be re-selected from the idle channels indicated by the first information other than channels already occupied by other devices, and the information is sent based on the channel re-selected.

In an optional embodiment of the present disclosure, receiving the first information may include:
receiving the first information sent by a first device, in which the idle channels indicated by the first information are determined by the first device by:
receiving signal information sent by each of second devices and determining the idle channels based on the signal information received.

For the first device, the idle channels may be determined by the following manner. Each device may acquire the signal information and then send the signal information to the first device. When receiving the signal information sent by each second device, the first device may determine the idle channels based on the signal information received.

The first device may periodically or nonperiodically receive the signal information from each second device, and then continuously determine the idle channels based on the signal information, and continuously determine the information configured to indicate the idle channels based on the new signal information received, thus ensuring that the information configured to indicate the idle channels is up-to-date.

In an optional embodiment, the signal information sent by each of the second devices includes at least one of: a signal strength, a signal type, and a signal feature of a signal.

The second device may acquire the signal information, which may include a signal strength of the signal acquired. The signal strength is configured to characterize a degree of strength of the signal.

The signal information may also include a signal type of the signal acquired, which may be a 5th generation mobile networks or 5th generation wireless systems or 5th-generation (abbreviated as 5G) signal, a 4th generation mobile communication technology (abbreviated as 4G) signal, or a 3rd generation telecommunication (abbreviated as 3G) signal, a 2-generation wireless telephone technology (abbreviated as 2G) signal, a wireless fidelity (abbreviated as Wi-Fi) signal, etc.

The signal information may also include a signal feature of the signal acquired. The signal feature is configured to represent feature information of the signal. For example, the acquired signal is one of synchronous signals in the 5G signal. The synchronous signal is a signal that provides a same time reference to machine equipments required to process information synchronously, and includes a plurality of signal sources emitted simultaneously from a same carrier.

When receiving the signal information acquired by the second devices, the first device may determine the idle channels based on at least one of the signal strength, the signal type, and the signal feature.

In an optional embodiment, receiving the first information includes receiving broadcast information, including the first information.

For the first information, the first device may broadcast the first information in a broadcasting manner. The first device may uniformly broadcast the first information on a dedicated broadcast channel. When broadcasting the first information, the first device may transmit at a certain power to ensure that all devices in a specific space may receive the broadcast information. The specific space may be understood as a room, a community, a building, a shopping mall, etc., which will not be limited herein.

The second device may be understood as a receiver (or also referred as a spectrum sensing point) capable of receiving signals. The second device is capable of sensing spectrum usage surrounding the second device, and transmitting signal information sensed to the first device responsible for broadcasting. The second device may transmit the signal information sensed to the first device responsible for broadcasting by means of wired or wireless transmission.

In an optional embodiment, the method in an embodiment of the present disclosure may further include: obtaining position information of a second device corresponding to each channel of the idle channels. Correspondingly, sending the information based on the idle channels indicated by the first information may include: determining a target channel from the idle channels indicated by the first information based on the position information of the second device corresponding to each channel; and sending the information based on the target channel.

In an embodiment, the position information of the second device corresponding to each channel of the idle channels may be obtained. Then, the target channel is determined from the idle channels indicated by the first information based on the position information of the second device corresponding to each channel, and the information is sent by the target channel.

There are various ways to obtain the position information of the second device corresponding to each channel of the idle channels, which specifically include the following methods.

Method B1: when sending the signal information to the first device, each second device may send the position information together to the first device. The first device may send the position information separately to a device to be sent information, alternatively, the first information may include the position information of the second device, and the first device may send the position information to the device to be sent information when sending the first information.

Method B2: in a practical application, the first device knows the position information of the second devices in advance. When sending the first information to the device to be sent information, the first device may directly send the position information of the second devices.

Method B3: the first information may include identification information of the second devices. The device to be sent information may obtain the position information of the second devices by querying in a table querying manner based on the identification information of the second devices.

After obtaining the position information of the second device corresponding to each channel of the idle channels according to the above method, the target channel may be selected based on the position information of the second devices. For example, a target channel corresponding to a second device closest to the device to be sent information may be selected. It is possible to avoid a position with a strong signal interference based on the position information of the second devices, such as a power plant. Understandably, there are no limitations on how to determine the target channel based on the position information.

In an optional embodiment, the target channel may also be determined in the following manner, which is performed by a device for sending information. Determining the target channel from the idle channels indicated by the first information based on the position information of the second device corresponding to each channel includes: determining the target channel from the idle channels indicated by the first information based on position information of the sending device and the position information of the second device corresponding to each channel.

In an embodiment, distances between the sending device and the second devices corresponding to respective channels may be obtained based on the position information of the sending device (i.e., the device to be sent information) and the position information of the second devices corresponding to respective channels. A channel with a closest distance from the idle channels indicated by the first information may be determined as the target channel.

According to this embodiment, the signal information acquired by the second devices may be received by the first device, and then the first device calculates the idle channels based on the signal information, and send the first information in a broadcasting manner based on the idle channels. When receiving the first information, a data sending device to be sent information may directly read the first information, and then send the information based on the idle channels indicated by the first information. When devices to be sent information are in a large number and are used simultaneously, these large-scale devices to be sent information are required to read the first information sent by the first device through a dedicated broadcast channel to obtain the idle channels without searching for a plurality of channels, and then send the information based on the idle channels, causing a plurality of devices to be sent information to use the channel resource more efficiently and reasonably, which may improve the utilization rate of the channel resource.

FIG. 2 is a flowchart illustrating another communication method according to an embodiment of the present disclosure. As illustrated in FIG. 2, the method may be performed by a first device, mainly include the following steps.

At step S201, signal information sent by each of second devices is obtained.

At step S202, idle channels are determined based on the signal information received.

At step S203, first information is sent based on the idle channels determined. The first information is configured to indicate the idle channels.

In an optional embodiment, sending the first information includes broadcasting the first information.

FIG. 3 is a flowchart illustrating yet another communication method according to an embodiment of the present disclosure. As illustrated in FIG. 3, the method may be performed by a second device, mainly include the following steps.

At step S301, signal information is acquired.

At step S301, the signal information is sent to a first device. The signal information is configured for the first device to determine an idle channel.

The communication methods illustrated in FIG. 2 and FIG. 3 and corresponding optional embodiments are described from perspectives of different execution subject matters. It can be understood that the content in FIG. 1, FIG. 2 and FIG. 3 may be referenced with each other. For example, explanation or description of the meaning of the same technology may be referred to, and many steps are also described from different perspectives. Therefore, the explanation of each optional embodiment corresponding to the communication method in FIG. 2 or FIG. 3 may refer to the previous description of each optional embodiment of the method illustrated in FIG. 1, and will not be repeated herein.

In an optional embodiment, the present disclosure also provides a communication network. The communication network includes a first device and second devices.

The second devices are configured to acquiring signal information and send the signal information to the first device.

The first device is configured to obtain the signal information sent by each of the second devices, determine idle channels based on the signal information received, and send first information based on the idle channels determined, in which the first information is configured to indicate the idle channels.

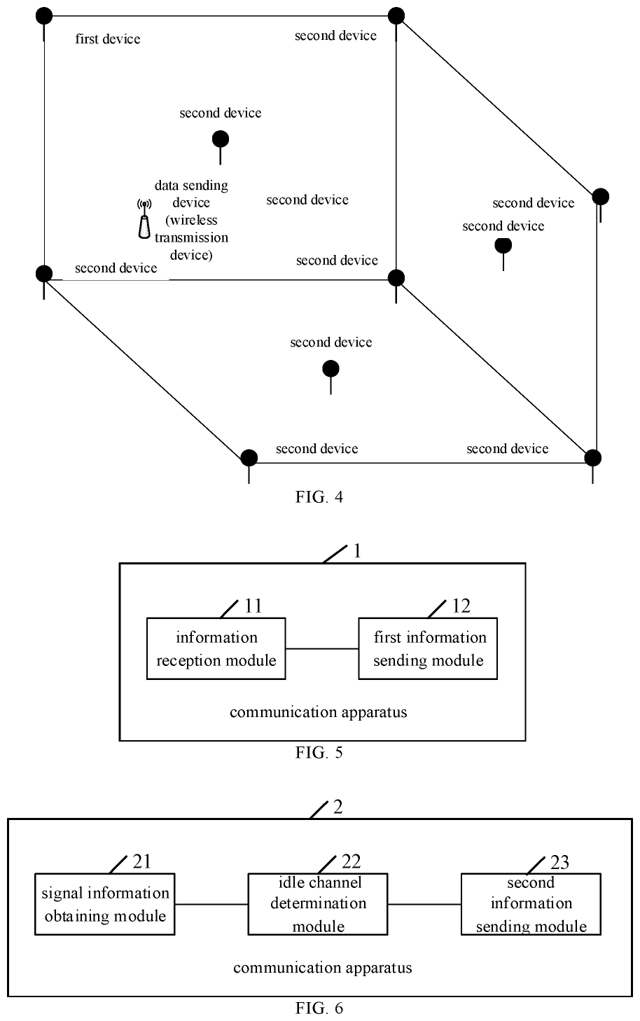

As an example, FIG. 4 is a schematic diagram illustrating a structure of a communication network according to an embodiment of the present disclosure. As illustrated in FIG. 4, the network includes several second devices, as well as the first device and a wireless transmission device.

As illustrated in FIG. 4, it can be seen that the network includes at least one second device. A first device responsible for broadcasting first information in FIG. 4 is located at an upper left corner. In a practical application, a position of the first device is not limited. For example, the first device may also be placed at a center point, an upper right corner, a bottom left corner, a bottom right corner, etc., in FIG. 4, as long as it ensures that the first information broadcasted by the first device may be received by all devices in a specific space (including the wireless transmission device to be sent information in FIG. 4). It can be understood that a position of the first device illustrated in FIG. 4 is only illustrative and may be set according to an actual requirement and an application scenario, which will not be limited herein.

Steps performed by the first device and the second devices in FIG. 4 may refer to the previous description, which will not be limited herein.

FIG. 5 is a schematic diagram illustrating a structure of a communication apparatus according to an embodiment of the present disclosure. The communication apparatus 1 provided in an embodiment of the present disclosure includes:
an information reception module 11, configured to receive first information, in which the first information is configured to indicate idle channels; and
first information sending module 12, configured to send information based on the idle channels indicated by the first information.

According to an embodiment of the present disclosure, the information is sent based on the idle channels indicated by the first information received, thus avoiding the existing method of searching a plurality of channels or even all channels within a specific spectrum to determine the idle channels, and directly determining the idle channels based on indication of the first information. Therefore, efficiency of determining the idle channels may be improved and the utilization rate of the channel resource may further be improved.

In some possible embodiments, the information reception module is configured to:
receive the first information sent by a first device, in which the idle channels indicated by the first information are determined by the first device by:
receiving signal information sent by each of second devices and determining the idle channels based on the signal information received.

In some possible embodiments, the first information sending module is configured to:
select one channel from the idle channels indicated by the first information;
send the information based on the channel selected.

In some possible embodiments, the first information sending module is configured to:
send the information based on the channel selected in response to the channel selected being unoccupied.

In some possible embodiments, the first information sending module is configured to:
randomly selecting one channel from the idle channels indicated by the first information.

In some possible embodiments, the information reception module is configured to:
receive second information in response to the channel selected being occupied, in which the second information is configured to indicate an idle channel; and
send the information based on the idle channel indicated by the second information.

In some possible embodiments, the information reception module is configured to:
in response to the channel selected being occupied, re-select one channel from the idle channels indicated by the first information other than the channel selected;
send the information based on the channel re-selected.

In some possible embodiments, the information reception module is configured to:
receive broadcast information including the first information.

In some possible embodiments, the signal information includes at least one of: a signal strength, a signal type, and a signal feature of a signal.

In some possible embodiments, the information reception module is configured to:
obtain position information of a second device corresponding to each channel of the idle channels;

The first information sending module is further configured to: determine a target channel from the idle channels indicated by the first information based on the position information of the second device corresponding to each channel; and
send the information based on the target channel.

In some possible embodiments, determining the target channel from the idle channels indicated by the first information based on position information of the sending device and the position information of the second device corresponding to each channel may be performed by a device for sending information.

FIG. 6 is a schematic diagram illustrating a structure of a communication apparatus according to an embodiment of the present disclosure. The communication apparatus 2 provided in an embodiment of the present disclosure may be applicable for a first device. The communication apparatus 2 includes:
a signal information obtaining module 21, configured to obtain signal information sent by each of second devices;
an idle channel determination module 22, configured to determine idle channels based on the signal information received; and
a second information sending module 23, configured to send first information based on the idle channels determined, in which the first information is configured to indicate the idle channels.

In some possible embodiments, the second information sending module is configured to:
broadcast the first information.

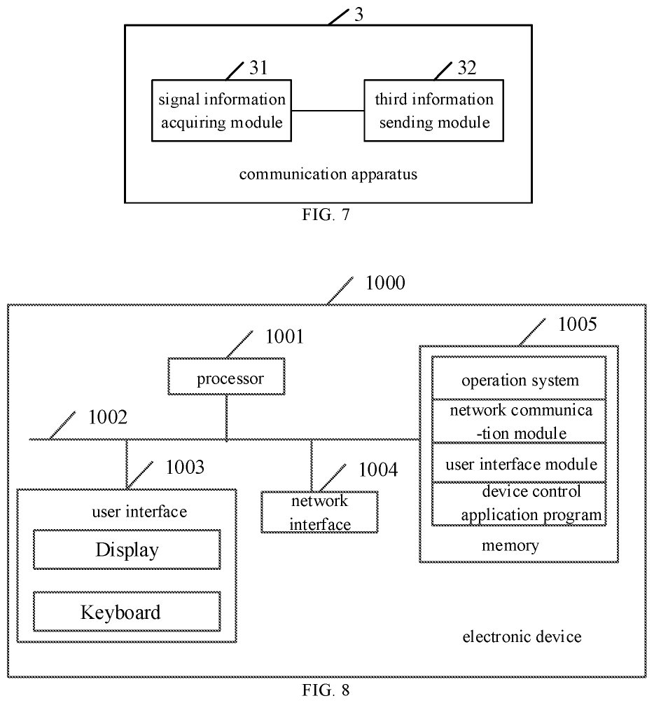

FIG. 7 is a schematic diagram illustrating a structure of a communication apparatus according to an embodiment of the present disclosure. The communication apparatus 2 provided in an embodiment of the present disclosure may be applicable for a second device. The communication apparatus 3 includes:
a signal information acquiring module 31, configured to acquiring signal information; and
a third information sending module 32, configured to send the signal information to a first device, in which the signal information is configured for the first device to determine an idle channel.

In the specific implementation, the apparatus 1 may execute an implementation provided by the steps as described in FIG. 1 by its built-in functional modules, the apparatus 2 may execute an implementation provided by the steps as described in FIG. 2 by its built-in functional modules, and the apparatus 3 may execute an implementation provided by the steps as described in FIG. 3 by its built-in functional modules. The details may refer to the implementation provided by any one of the foregoing steps, and will not repeated herein.

FIG. 8 is a schematic diagram illustrating an electronic device according to an embodiment of the disclosure. As illustrated in FIG. 8, an electronic device 100 in this embodiment may include a processor 1001, a network interface 1004, and a memory 1005. In addition, the electronic device 1000 may also include: a user interface 1003, and at least one communication bus 1002. The communication bus 1002 is used to achieve connection communication between these components. The user interface 1003 may include a display and a keyboard, and the user interface 1003 may optionally include a standard wired interface and a standard wireless interface. The network interface 1004 may optionally include standard wired interface and a standard wireless interface (such as a WI-FI interface). The memory 1005 may be a high-speed RAM (random access memory) memory or a non-volatile memory, such as at least one disk storage. The memory 1005 may optionally be at least one storage device located away from the aforementioned processor 1001. As illustrated in FIG. 8, the memory 1005, as a computer-readable storage medium, may include an operation system, a network communication module, a user interface module, and a device control application program.

In the electronic device 1000 illustrated in FIG. 8, the network interface 1004 may provide a network communication function. The user interface 1003 is mainly configured to provide an input interface for a user. The processor 1001 may be configured to call the device control application program stored in memory 1005 to implement the followings.

In some possible embodiments, the processor 1001 is configured to:
receive first information, in which the first information is configured to indicate idle channels;
send information based on the idle channels indicated by the first information.

It should be understood that in some possible embodiments, the processor 1001 may be a central processing unit (CPU), and may also be any other general-purpose processor, a digital signal processor (DSP), an application specific integrated circuits (ASIC), a field-programmable gate array (FPGA) or any other programmable logic device, a discrete gate or transistor logic device, a discrete hardware component, etc. A general-purpose processor may be a microprocessor or any conventional processor. The memory may include a read-only memory and a random access memory, and provide instructions and data to the processor. A part of the memory may also include the non-volatile random access memory. For example, the memory may also store information about device types.

In the specific implementation, the above electronic device 1000 may execute the implementation provided by the steps as described in any one of FIG. 1, FIG. 2, and FIG. 3 by its built-in functional modules. The details may refer to the implementation provided by any one of the foregoing steps, and will not repeated herein.

An embodiment of the present disclosure also provides a computer readable storage medium having a computer program stored thereon. The computer program is caused to implement the method provided by the steps as described in any one of FIG. 1, FIG. 2, and FIG. 3 when executed by a processor. The details may refer to the implementation provided by any one of the foregoing steps, and will not repeated herein.

The above computer readable storage medium may be an internal storage unit of a task processing device provided by any one of the foregoing embodiments, such as a hard disk or a memory of an electronic device. The computer readable storage medium may also be an external storage device of the electronic device, such as a plug-in hard disk, a smart media card (SMC), a secure digital (SD) card, a flash card, etc. provided with the electronic device. The above computer readable storage media may also include a magnetic disk, an optical disc, a read-only memory (ROM) or a random access memory (RAM), etc. Furthermore, the computer readable storage medium may include both the internal storage unit of the electronic device and the external storage device. The computer readable storage medium is configured to store a computer program and other programs and data required by the electronic device. The computer readable storage medium may also be configured to temporarily store data that has been or is to be output.

An embodiment of the present disclosure provides a computer program product or a computer program, which includes computer instructions stored on a computer readable storage medium. A processor of an electronic device reads the computer instructions from the computer readable storage medium, and the processor executes the computer instructions causing the computer device to implement the method provided by the steps as described in any one of FIG. 1, FIG. 2, and FIG. 3.

The terms “first”, “second”, etc. in specification and claims of the present disclosure, as well as the accompanying drawings, are used to distinguish similar objects, rather than to describe a specific order. In addition, the “including” and “having”, as well as any variations thereof, are intended to cover non-exclusive inclusion. For example, a process, a method, a system, a product, or an electronic device that includes a series of steps or units is not limited to listed steps or units, but optionally includes unlisted steps or units, or optionally includes other steps or units inherent to the process, the method, the product, or the electronic device. The reference to “embodiment” in the present disclosure means that specific features, structures, or characteristics described in combination with the embodiment may be included in at least one embodiment of the present disclosure. The phrase displayed in various positions in the specification does not necessarily refer to the same embodiment, nor is it an independent or alternative embodiment that is mutually exclusive with other embodiments. Those skilled in the art explicitly and implicitly understand that an embodiment described in the present disclosure can be combined with other embodiments. The term “and/or” used in the specification of the present disclosure and the accompanying claims refers to any combination and all possible combinations of one or more of related listed items, and includes these combinations.

Those ordinary skilled in the art may realize that units and algorithm steps of each example described in combination with the embodiments disclosed in present disclosure can be implemented by means of electronic hardware, computer software, or a combination of both. In order to clearly illustrate the interchangeability of hardware and software, composition and steps of each example have been described in general terms according to their functions in the above description. Those professional skilled may use different methods to implement the described functions for each specific application, but such implementation should not be considered beyond the scope of the present disclosure.

The above disclosure is only a preferred embodiment of the present disclosure, and cannot be used to limit the scope of claims in the present disclosure. Therefore, equivalent changes made according to claims the present disclosure still fall within the scope of the present disclosure.

1. A communication method, performed by a sending device, comprising:
receiving first information, wherein the first information is configured to indicate idle channels; and
sending information based on the idle channels indicated by the first information.

2. The method according to claim 1, wherein receiving the first information comprises:
receiving the first information sent by a first device, wherein the idle channels indicated by the first information are determined by the first device by:
receiving signal information sent by each of second devices and determining the idle channels based on the signal information received.

3. The method according to claim 1, wherein sending the information based on the idle channels indicated by the first information comprises:
selecting one channel from the idle channels indicated by the first information; and
sending the information based on the channel selected.

4. The method according to claim 3, wherein sending the information based on the channel selected comprises:
sending the information based on the channel selected in response to the channel selected being unoccupied.

5. The method according to claim 3, wherein selecting one channel from the idle channels indicated by the first information comprises:
randomly selecting one channel from the idle channels indicated by the first information.

6. The method according to claim 3, further comprising:
receiving second information in response to the channel selected being occupied, wherein the second information is configured to indicate an idle channel; and
sending the information based on the idle channel indicated by the second information.

7. The method according to claim 3, wherein sending the information based on the channel selected comprises:
in response to the channel selected being occupied, re-selecting one channel from the idle channels indicated by the first information other than the channel selected; and
sending the information based on the channel re-selected.

8. The method according to claim 1, wherein receiving the first information comprises:
receiving broadcast information comprising the first information.

9. The method according to claim 2, wherein the signal information comprises at least one of:
a signal strength, a signal type, and a signal feature of a signal.

10. The method according to claim 2, further comprising:
obtaining position information of a second device corresponding to each channel of the idle channels;
wherein sending the information based on the idle channels indicated by the first information comprises:
determining a target channel from the idle channels indicated by the first information based on the position information of the second device corresponding to each channel; and
sending the information based on the target channel.

11. The method according to claim 10, wherein determining the target channel from the idle channels indicated by the first information based on the position information of the second device corresponding to each channel comprises:
determining the target channel from the idle channels indicated by the first information based on position information of the sending device and the position information of the second device corresponding to each channel.

12. A communication method, performed by a first device, comprising:
obtaining signal information sent by each of second devices;
determining idle channels based on the signal information received; and
sending first information based on the idle channels determined, wherein the first information is configured to indicate the idle channels.

13. The method according to claim 12, wherein sending the first information comprises:
broadcasting the first information.

14. A communication method, performed by a second device, comprising:
acquiring signal information; and
sending the signal information to a first device, wherein the signal information is configured for the first device to determine an idle channel.

15.-19. (canceled)

19. An electronic sending device, comprising a processor and a memory, coupled with each other, wherein:
the memory is configured to store a computer program; and
the processor is configured to implement the method of claim 1 when calling the computer program.

20. A computer readable storage medium having a computer program stored thereon, wherein the computer program is caused to implement the method according to claim 1 when executed by a processor.

21. A first device, comprising a processor and a memory, coupled with each other, wherein
the memory is configured to store a computer program; and
the processor is configured to implement the method according to claim 12 when calling the computer program.

22. A second device, comprising a processor and a memory, coupled with each other, wherein:
the memory is configured to store a computer program; and
the processor is configured to implement the method according to claim 14 when calling the computer program.

23. A computer readable storage medium having a computer program stored thereon, wherein the computer program is caused to implement the method according to claim 12 when executed by a processor.

24. A computer readable storage medium having a computer program stored thereon, wherein the computer program is caused to implement the method according to claim 14 when executed by a processor.
